(19) United States
(12) Patent Application Publication
(10) Pub. No.: US 2025/0373428 A1
(43) Pub. Date: Dec. 4, 2025

(54) HOMOMORPHIC ENCRYPTION FOR EMBEDDINGS

(71) Applicant: American Express Travel Related Services Company, Inc., New York, NY (US)

(72) Inventor: Dagen Wang, Houston, TX (US)

(21) Appl. No.: 18/678,666

(22) Filed: May 30, 2024

(51) Int. Cl. H04L 9/32; G06F 21/62; G06F 40/284

(52) U.S. Cl. CPC H04L 9/3213; G06F 21/6218; G06F 40/284

(57) ABSTRACT

Disclosed are various embodiments for homomorphic encryption for embeddings. A prompt is tokenized to generate a plurality of prompt tokens. A respective prompt embedding is generated for each of the plurality of prompt tokens, the respective prompt embedding for each of the plurality of prompt tokens representing an encoding of each of the plurality of prompt tokens in a high-dimensional vector space. Then, the respective prompt embedding for each of the plurality of prompt tokens is encrypted by rotating the respective prompt embedding through the high-dimensional vector space to generate a respective encrypted prompt embedding for each of the plurality of prompt tokens.

### BACKGROUND

Data is often stored at rest in encrypted form to protect the data from theft or accidental disclosure. When the data needs to be accessed or used, it is often decrypted to allow the data to be processed, searched, or otherwise manipulated. It can then be re-encrypted for continuing storage, such as when changes are made to the unencrypted data. However, encrypting and decrypting data is computationally expensive and can take significant amounts of time. Accordingly, decrypting frequently accessed data each time it needs to be accessed can substantially reduce the performance of any applications that need to access the data in decrypted form. Moreover, caching the data in an unencrypted form circumvents the security benefits of storing data in encrypted form.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of a network environment according to various embodiments of the present disclosure.

FIG. 1B is a drawing of a network environment according to various embodiments of the present disclosure.

FIG. 2 is a flow chart illustrating one example of functionality implemented as portions of an application executed in a computing environment in the network environment of FIG. 1A of 1B according to various embodiments of the present disclosure.

FIG. 3 is a flow chart illustrating one example of functionality implemented as portions of an application executed in a computing environment in the network environment of FIG. 1A according to various embodiments of the present disclosure.

FIG. 4 is a sequence diagram illustrating one example of functionality implemented in the network environment of FIG. 1B according to various embodiments of the present disclosure.

### DETAILED DESCRIPTION

Large language models (LLMs), small language models (SLMs), and similar machine learning models use embeddings to encode information about individual words, phrases, or tokens used to represent natural language. When performing natural language processing, large numbers of embeddings are often accessed and evaluated to process a natural language query and generate a natural language response that is meaningful. Commercially available LLMs and SLMs often access these stored embeddings so frequently that storing the embeddings in encrypted form is impractical due to the computing costs associated with repeatedly decrypting the embeddings each time they are accessed. Although an unencrypted cache of the embeddings could be stored to decrease the latency introduced with each decryption performed to access the encrypted embeddings, such a cache would undermine the security of provided by storing the embeddings in encrypted form.

Accordingly, disclosed are various approaches for storing machine learning embeddings, such as those used by large language models (LLMs), small language models (SLMs), and similar systems, in a homomorphically encrypted manner. Homomorphic encryption refers to encryption systems or schemas that allow computing operations to be performed on encrypted data without first having to decrypt it. Various bodies of the present disclosure use an encryption matrix to rotate embeddings through a vector space to generate encrypted embeddings. Various operations (e.g., similarity searches) can continue to be performed on the encrypted embeddings without knowledge of the underlying, unencrypted values for the embeddings because the relative positions of the encrypted embeddings are preserved by the rotation.

The homomorphically encrypted embeddings of the various embodiments of the present disclosure offer a number of technical advantages over previous approaches for storing embeddings used by machine-learning models in an encrypted form. First, the encrypted embeddings do not have to be decrypted, but can be searched in encrypted form to arrive at the same results. Accordingly, various embodiments of the present disclosure consume fewer computing resources and can process requests more quickly because they do not require the embeddings to be decrypted prior to use. Moreover, various embodiments of the present disclosure offer security advantages over other systems because the various embodiments of the present disclosure do not require data to be stored in unencrypted form.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

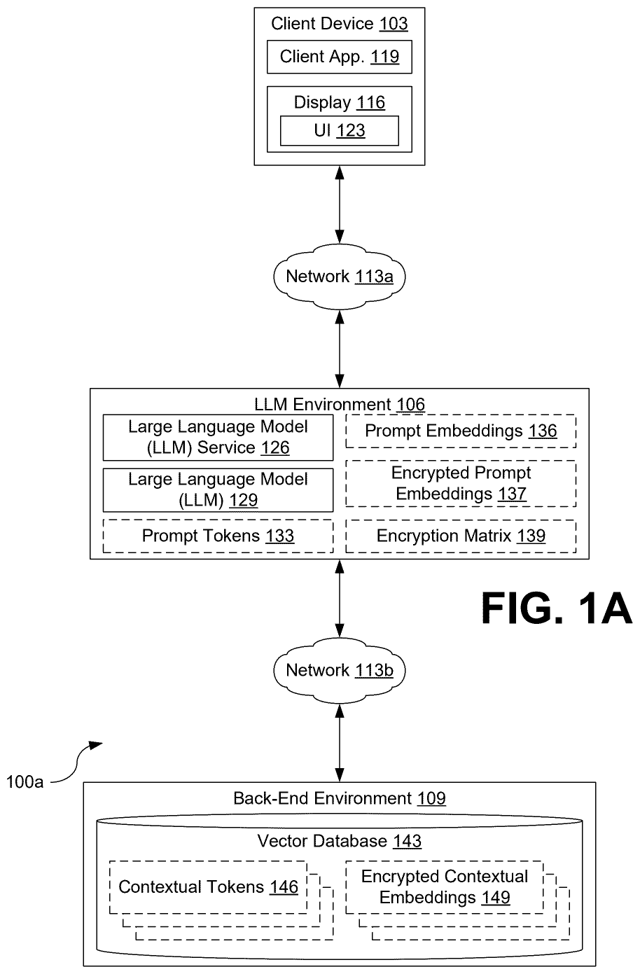

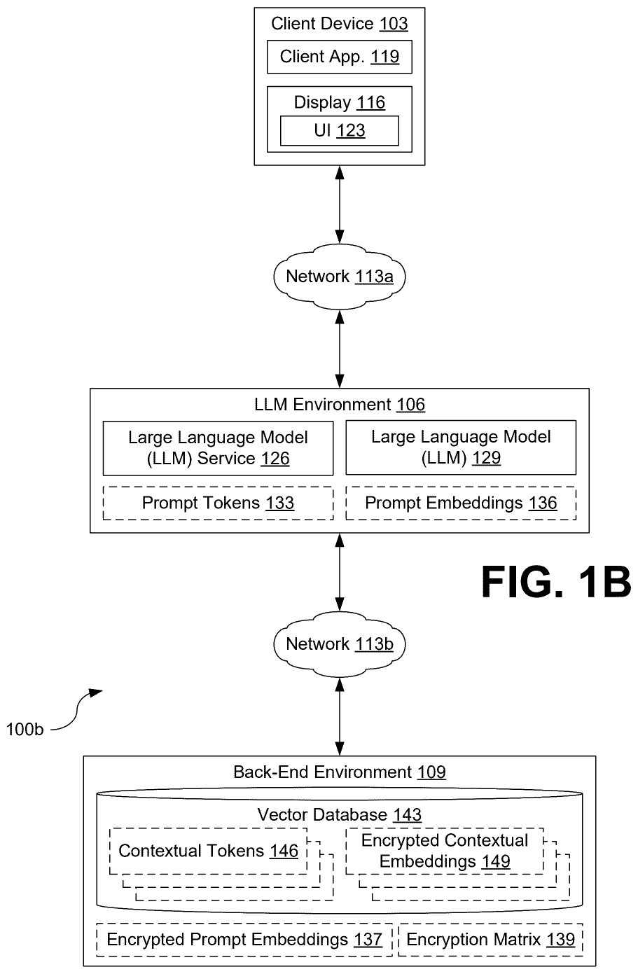

FIG. 1A represents a network environment 100a according to various embodiments. The network environment 100a can include a client device 103, a large language model (LLM) environment 106, and/or a back-end environment 109, which can be in data communication with each other via one or more networks 113 (e.g., network 113a and network 113b, collectively referred to as networks 113 and generically as a network 113). In some instances, the client device 103, LLM environment 106, and the back-end environment 109 can communicate with each other via separate networks 113 as depicted. In other instances, the client device 103, LLM environment 106, and the back-end environment 109 can communicate with each other via the same network 113.

A network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The client device 103 is representative of a plurality of client devices that can be coupled to a network 113. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 116, such as liquid crystal displays (LCDs), gas plasma-based flat panel displays, organic light emitting diode (OLED) displays, electrophoretic ink (“E-ink”) displays, projectors, or other types of display devices. In some instances, the display 116 can be a component of the client device 103 or can be connected to the client device 103 through a wired or wireless connection.

The client device 103 can be configured to execute various applications such as a client application 119 or other applications. The client application 119 can be executed in a client device 103 to access network content served up by the LLM environment 106 or other servers, thereby rendering a user interface 123 on the display 116. To this end, the client application 119 can include a browser, a dedicated application, or other executable, and the user interface 123 can include a network page, an application screen, or other user mechanism for obtaining user input.

The LLM environment 106 and the back-end environment 109 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the LLM environment 106 and the back-end environment 109 can employ a plurality of computing devices that can be arranged in one or more server banks or computer banks or other arrangements. Such computing devices can be located in a single installation or can be distributed among many different geographical locations. For example, the LLM environment 106 and the back-end environment 109 can include a plurality of computing devices that together can include a hosted computing resource, a grid computing resource or any other distributed computing arrangement. In some cases, the LLM environment 106 and the back-end environment 109 can correspond to an elastic computing resource where the allotted capacity of processing, network, storage, or other computing-related resources can vary over time.

However, although the LLM environment 106 and the back-end environment 109 are depicted and described separately, some embodiments of the present disclosure may operate using a single computing environment that provides the functionality of both the LLM environment 106 and the back-end environment 109. For example, an implementation of the present disclosure could host the components depicted herein in a shared tenancy cloud computing environment (e.g., AMAZON® Web Services (AWS), MICROSOFT® AZURE®, GOOGLE® Cloud Compute (GCP), etc.). In these implementations, all of the components could be hosted by the same cloud computing environment.

Various applications or other functionality can be executed in the LLM environment 106. The components executed on LLM environment 106 include a large language model (LLM) service 126 and an LLM 129, which may be collectively referred to as an LLM in some contexts, and other applications, services, processes, systems, engines, or functionality not discussed in detail herein.

The LLM service 126 can be executed to act as a front-end interface for the LLM 129. For example, the LLM service 126 can be executed to receive prompts or other inputs for the LLM 129 and preprocess them for use or consumption by the LLM 129. This can include tokenizing the prompts to generate one or more prompt tokens 133, generating respective prompt embeddings 136 for the prompt tokens 133, encrypting prompt embeddings 136 to create encrypted prompt embeddings 137 for performing encrypted search, submitting inputs to the LLM 129, and returning the results from the LLM 129 to the requesting client application 119 or client device 103.

The LLM 129 represents a machine-learning model that can be executed to generate natural language text based upon inputs received from the LLM service 126. This can be done, for example, by receiving input text and repeatedly predicting the next word or token for a response. In order to generate responses, the LLM 129 may learn statistical relationships between words, phrases, or other tokens from a corpus of training text in a self-supervised or semi-supervised training process. Examples of LLMs 129 include OPENAI's® generative pre-trained transformer (GPT) models, GOOGLE's® PALM and GEMINI models, META's® LLAMA models, etc.

Various other types of data can also be stored within the LLM environment 106, such as prompt tokens 133, prompt embeddings 136, and an encryption matrix 139.

Prompt tokens 133 represent individual tokens resulting from the tokenization of a prompt provided to the LLM service 126. Individual prompt tokens 133 can represent lexical tokens that represent individual words, phrases, punctuation, numbers, symbols, or combinations thereof that are present within a prompt. The lexical tokenization algorithm or technique selected can determine how prompt tokens 133 are created from tokenizing a given prompt.

Prompt embeddings 136 are embeddings that provide additional context or meaning for a token in a machine-readable and machine-understandable manner, which can be processed by the LLM 129. An embedding is a vector or array in a multi-dimensional space that represents the meaning and context of tokens. Accordingly, for each prompt token 133, a respective prompt embedding 136 is a vector or array in a multi-dimensional space that represents the meaning and context of the respective prompt token 133. Generally, prompt embeddings 136 that are closer together in the multi-dimensional vector space are expected to represent prompt tokens 133 that are similar in meaning. Moreover, each prompt embedding 136 can be expected to have the same number of dimensions in order to facilitate processing of each prompt embedding 136. Prompt embeddings 136 can be generated using various language modeling or feature learning techniques, where words, phrases, and/or other tokens are mapped to vectors of real numbers. Examples of these techniques include bag-of-words (BoW) or continuous bag-of-words (CBow) approaches, continuously sliding skip-gram approaches, and transformer architecture approaches. Examples of software for generating embeddings include Tomas Mikolov's word2vec, Stanford's GloVe, and GOOGLE's® Bidirectional Encoder Representations from Transformers (BERT).

The encrypted prompt embeddings 137 are the respective encrypted versions of the prompt embeddings 136. Each encrypted prompt embedding 137 can be generated by encrypting a respective prompt embedding 136 using the encryption matrix 139.

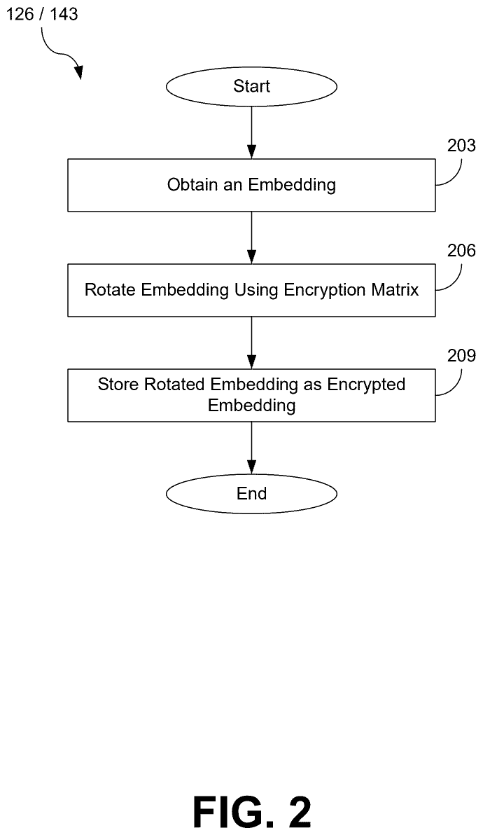

The encryption matrix 139 represents a unitary rotational matrix with the same dimensions as the prompt embeddings 136 that will be encrypted with the encryption matrix 139. The encryption matrix 139, as discussed later with respect to FIG. 2, can be used as an encryption key to encrypt individual prompt embeddings 136 by rotating the individual prompt embeddings through a multidimensional space by multiplying the prompt embedding 136 with the encryption matrix 139. The use of a unitary matrix for the encryption matrix 139 allows for encryption operations to be reversed, if necessary.

The back-end environment 109 can be used to host resources for supporting the operation of the LLM service 126 and/or the LLM 129. For example, back-end environment 109 could host a vector database 143. The vector database 143 could store information such as one or more encrypted contextual embeddings 149 that could be used as part of the operation of the LLM 129. The vector database 143 can include any database or data store that can store vectors in association with other items. Accordingly, the vector database 143 could be used to store one or more contextual tokens 146 in associate with one or more encrypted contextual embeddings 149.

Contextual tokens 146 are additional tokens that can be used to supplement or provide additional information to the LLM 129 about a prompt submitted by a user to the LLM service 126. Contextual tokens 146 can be used to augment a prompt submitted by a user, as further discussed later. Contextual tokens 146 could be obtained from a variety of sources. For example, various corpuses of text (e.g., news articles, textbooks, reference books, academic journal articles, published patent applications, public records, social media posts, internet blog posts, etc.) could be tokenized using various tokenizing algorithms or techniques to generate contextual tokens 146.

Encrypted contextual embeddings 149 are embeddings that provide additional context or meaning for a respective contextual token 146. An embedding is a vector or array in a multi-dimensional space that represents the meaning and context of tokens. Each contextual token 146 can have a respective contextual embedding 149 that encodes additional context or meaning for the respective contextual token 146.

For the purposes of the various embodiments depicted in FIG. 1A, the encrypted contextual embeddings 149 have been previously encrypted using the encryption matrix 139. For example, in an initialization or setup stage, the contextual tokens 146 generated from various source materials could be processed to generated respective embeddings using various embedding generation approaches or techniques. These respective embeddings can then be encrypted using the encryption matrix 139 to generate the encrypted contextual embeddings 149. Each contextual token 146 can be stored with an encrypted contextual embedding 149.

Next, a general description of the operation of the various components of the network environment 100a is provided. Although the following description provides an example of the operation of the various components of the network environment 100a, other operations are also encompassed by the various embodiments of the present disclosure.

To begin, a user of the client device 103 can use the client application 119 to submit a prompt to the LLM service 126. The prompt can represent a piece of text that, when provided to an LLM 129, instructs the LLM 129 to generate a response. The prompt can be submitted, for example, through a web-form or other web-based interface provided by the LLM service 126. As another example, the prompt can be transmitted to the LLM service 126 using an application programming interface (API) provided by the LLM service 126.

The LLM service 126 can the process or otherwise prepare the prompt for submission to the LLM 129. For example, the LLM service 126 can tokenize the prompt to generate one or more prompt tokens 133 using various tokenizing algorithms or techniques. The LLM service 126 can then generate a respective prompt embedding 136 for each prompt token 133 using various embedding generation techniques.

The prompt embeddings 136 can then be encrypted using the encryption matrix 139 to generated encrypted prompt embeddings 137. This can be accomplished by performing a matrix multiplication with the encryption matrix 139 for each prompt embedding 136 to rotate the prompt embedding 136 through the vector space of the prompt embedding 136. After generating the encrypted prompt embeddings, the LLM service 126 can send the encrypted prompt embeddings 137 to the vector database 143. In some instances, the encrypted prompt embeddings 137 can be sent over a secure connection (e.g., a network connection secured using a version of the transport layer security (TLS) protocol).

The vector database 143 can then use the encrypted prompt embeddings 137 to search for similar encrypted contextual embeddings 149. Because the encrypted prompt embeddings 137 and the encrypted contextual embeddings 149 have both been encrypted using the same encryption matrix 139, both the encrypted prompt embeddings 137 and the encrypted contextual embeddings 149 have been rotated by the same degree through the same vector space. Accordingly, the relative positions of the encrypted prompt embeddings 137 and the encrypted contextual embeddings 149 can remain the same as the relative positions of the unencrypted prompt embeddings 137 and the unencrypted versions of the encrypted contextual embeddings 149. Therefore, a search for encrypted contextual embeddings 149 that are similar to the encrypted prompt embeddings 137 could yield the same results as a search for unencrypted versions of the encrypted contextual embeddings 149 that are similar to the unencrypted prompt embeddings 137. Similarity can be defined according to various criteria (e.g., a minimum distance between two embeddings within the vector space).

After identifying the similar encrypted contextual embeddings 149, the vector database 143 can retrieve the respective contextual tokens 146. The vector database 143 can then return the respective contextual tokens 146 to the LLM service 126. Because the respective contextual tokens 146 are stored in unencrypted form, the vector database 143 can return the respective contextual tokens 146 over a secure communications channel (e.g., a network connection secured using a version of the transport layer security (TLS) protocol).

After receiving the contextual tokens 146 identified by the vector database 143 #, the LLM service 126 can combine the prompt tokens 133 and the contextual tokens 146 into an LLM prompt that is submitted to the LLM 129. The LLM 129 can then generate a response based at least in part on the combination of the prompt tokens 133 and the contextual tokens 146 present in the LLM prompt. The LLM 129 can then return the response to the LLM service 126, which can return the response to the client application 119. The client application 119 can, in turn, show or present the response within a user interface 123 outputted on the display 116 of client device 103.

FIG. 1B depicts a network environment 100b according to various embodiments. The network environment 100b can include a client device 103, a large language model (LLM) environment 106, and/or a back-end environment 109, which can be in data communication with each other via one or more networks 113 (e.g., network 113a and network 113b, collectively referred to as networks 113 and generically as a network 113). In some instances, the client device 103, LLM environment 106, and the back-end environment 109 can communicate with each other via separate networks 113 as depicted. In other instances, the client device 103, LLM environment 106, and the back-end environment 109 can communicate with each other via the same network 113.

In contrast to the network environment 100a of FIG. 1A, the network environment 100b of FIG. 1B depicts the encryption matrix 139 being located within the back-end environment 109. In this situation, key management does not need to be handled by the LLM service 126. Instead, prompt embeddings 136 can be encrypted by the vector database 143 using the encryption matrix 139 in order to generated encrypted prompt embeddings 137 for use in searching the vector database 143, as discussed later. This simplifies key management for the operator of the LLM service 126, but potentially exposes the encryption matrix 139 to third-parties (e.g., if the back-end environment 109 is hosted by a third-party).

Next, a general description of the operation of the various components of the network environment 100b is provided. Although the following description provides an example of the operation of the various components of the network environment 100b, other operations are also encompassed by the various embodiments of the present disclosure.

To begin, a user of the client device 103 can use the client application 119 to submit a prompt to the LLM service 126. The prompt can represent a piece of text that, when provided to an LLM 129, instructs the LLM 129 to generate a response. The prompt can be submitted, for example, through a web-form or other web-based interface provided by the LLM service 126. As another example, the prompt can be transmitted to the LLM service 126 using an application programming interface (API) provided by the LLM service 126.

The LLM service 126 can the process or otherwise prepare the prompt for submission to the LLM 129. For example, the LLM service 126 can tokenize the prompt to generate one or more prompt tokens 133 using various tokenizing algorithms or techniques. The LLM service 126 can then generate a respective prompt embedding 136 for each prompt token 133 using various embedding generation techniques. The prompt embeddings 136 can then be sent to the vector database 143 using a secure communications channel (e.g. a network connection secured using a version of the transport layer security (TLS) protocol).

The vector database 143 can then encrypt the prompt embeddings 136 to generate encrypted prompt embeddings 137 using the encryption matrix 139. This can be accomplished by performing a matrix multiplication with the encryption matrix 139 for each prompt embedding 136 to rotate the prompt embedding 136 through the vector space of the prompt embedding 136. After generating the encrypted prompt embeddings, the LLM service 126 can send the encrypted prompt embeddings 137 to the vector database 143. In some instances, the encrypted prompt embeddings 137 can be sent over a secure connection (e.g., a network connection secured using a version of the transport layer security (TLS) protocol).

The vector database 143 can then use the encrypted prompt embeddings 137 to search for similar encrypted contextual embeddings 149. Because the encrypted prompt embeddings 137 and the encrypted contextual embeddings 149 have both been encrypted using the same encryption matrix 139, both the encrypted prompt embeddings 137 and the encrypted contextual embeddings 149 have been rotated by the same degree through the same vector space. Accordingly, the relative positions of the encrypted prompt embeddings 137 and the encrypted contextual embeddings 149 remain the same as the relative positions of the unencrypted prompt embeddings 137 and the unencrypted versions of the encrypted contextual embeddings 149. Therefore, a search for encrypted contextual embeddings 149 that are similar to the encrypted prompt embeddings 137 will yield the same results as a search for unencrypted versions of the encrypted contextual embeddings 149 that are similar to the unencrypted prompt embeddings 136. Similarity can be defined according to various criteria (e.g., a minimum distance between two embeddings within the vector space).

After identifying the similar encrypted contextual embeddings 149, the vector database 143 can retrieve the respective contextual tokens 146. The vector database 143 can then return the respective contextual tokens 146 to the LLM service 126. Because the respective contextual tokens 146 are stored in unencrypted form, the vector database 143 can return the respective contextual tokens 146 over a secure communications channel (e.g., a network connection secured using a version of the transport layer security (TLS) protocol).

After receiving the contextual tokens 146 identified by the vector database 143 #, the LLM service 126 can combine the prompt tokens 133 and the contextual tokens 146 into an LLM prompt that is submitted to the LLM 129. The LLM 129 can then generate a response based at least in part on the combination of the prompt tokens 133 and the contextual tokens 146 present in the LLM prompt. The LLM 129 can then return the response to the LLM service 126, which can return the response to the client application 119. The client application 119 can, in turn, show or present the response within a user interface 123 outputted on the display 116 of client device 103.

Referring next to FIG. 2, shown is a flowchart that provides one example of the encryption process for encrypting embeddings (e.g., for creating encrypted prompt embeddings 137 from respective prompt embeddings 136 or for creating encrypted contextual embeddings 149 from respective contextual embeddings). Accordingly, the flowchart of FIG. 2 depicts a sequence of operations that could be performed by the LLM service 126 or the vector database 143 according to various embodiments of the present disclosure. As an alternative, the flowchart of FIG. 2 can be viewed as depicting an example of elements of a method implemented within the network environment 100a or the network environment 100b.

Beginning with block 203, the LLM service 126 or the vector database 143 can receive one or more unencrypted embeddings (e.g., unencrypted contextual embeddings or unencrypted prompt embeddings 137). For example, the LLM service 126 could generate the unencrypted prompt embeddings 137 from one or more prompt tokens 133. As another example, the vector database 143 could receive the unencrypted prompt embeddings 137 from the LLM service 126 or the vector database 143 could receive unencrypted contextual embeddings as part of a training set of data.

Then, at block 206, the LLM service 126 or the vector database 143 can encrypt the embeddings obtained at block 203 using the encryption matrix 139. For example, the LLM service 126 or the vector database 143 could perform a rotation of the embeddings by performing a matrix multiplication between each embedding and the encryption matrix 139 to rotate each embedding through the vector space.

Next, at block 209, the LLM service 126 or the vector database 143 can store the rotated embeddings as encrypted embeddings (e.g., as encrypted prompt embeddings 137 or encrypted contextual embeddings 149). Once the encrypted embeddings are stored, the encryption process can end.

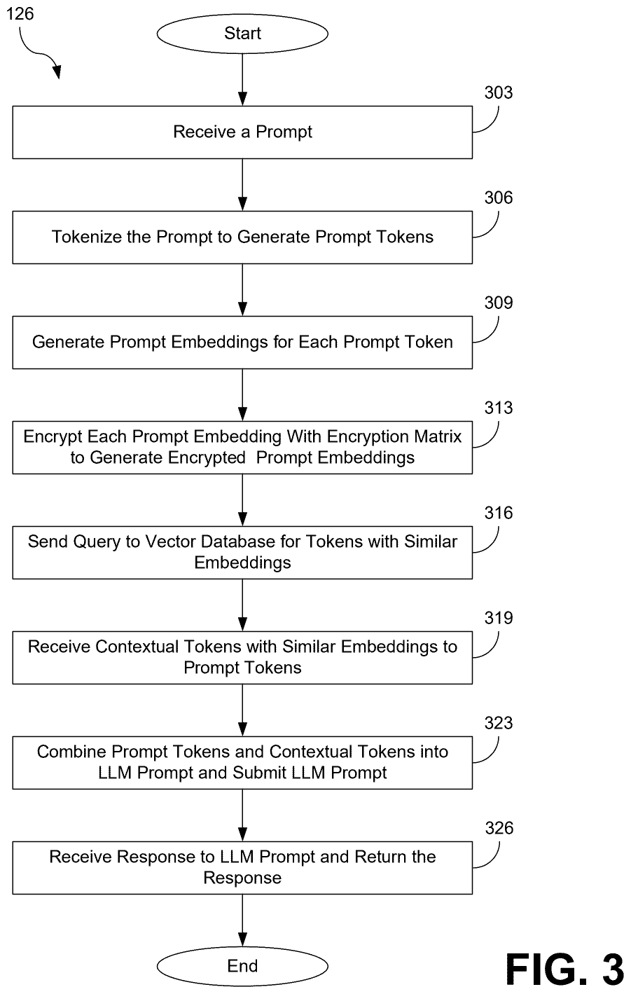

Referring next to FIG. 3, shown is a flowchart that provides one example of the operation of a portion of the LLM service 126, such as the LLM service 126 depicted in FIG. 1A. The flowchart of FIG. 3 provides merely an example of the many different types of functional arrangements that can be employed to implement the operation of the depicted portion of the LLM service 1216. As an alternative, the flowchart of FIG. 3 can be viewed as depicting an example of elements of a method implemented within the network environment 100a.

Beginning with block 303, the LLM service 126 can receive a prompt. For example, the LLM service 126 could receive a prompt from a client application 119 executing on the client device 106. The prompt could be submitted by the client application 119 using a web-based interface (e.g., text entered into a webform on a website), through an application programming interface (API) (e.g., as arguments included in an function call for a function provided by the API), etc.

Then, at block 306, the LLM service 126 can tokenize the prompt received at block 303 to generate one or more prompt tokens 133. Various tokenizing algorithms and delimiters could be used to separate the prompt into one or more lexical tokens representing words, phrases, numbers, symbols, punctuation, etc.

Next, at block 309, the LLM service 126 can generate a prompt embedding 136 for each token generated at block 306. Prompt embeddings 136 can be generated using various language modeling or feature learning techniques, where words, phrases, and/or other tokens are mapped to vectors of real numbers. Examples of these techniques include bag-of-words (BoW) or continuous bag-of-words (CBow) approaches, continuously sliding skip-gram approaches, and transformer architecture approaches. Examples of software for generating embeddings include Tomas Mikolov's word2vec, Stanford's GloVe, and GOOGLE's® Bidirectional Encoder Representations from Transformers (BERT).

Moving on to block 313, the LLM service 126 can encrypt each prompt embedding 136 generated at block 309 with the encryption matrix 139 to generate respective encrypted prompt embeddings 137. This can be done my multiplying each prompt embedding 136 with the encryption matrix 139 to rotate the prompt embedding 136 through its vector space. The matrix resulting from the rotation is the respective encrypted prompt embedding 137 for the prompt embedding 136.

Subsequently, at block 316, the LLM service 126 can send the encrypted prompt embeddings 137 to a vector database 143. The encrypted prompt embeddings 137 can be sent over a secure network connection to the vector database (e.g., a network connection secured using a version of the transport layer security (TLS) protocol) or could be sent in the clear because the encrypted prompt embeddings 137 have already been encrypted at block 313.

Proceeding to block 319, the LLM service 126 can receive one or more contextual tokens 146 from the vector database 143 in response to sending the encrypted prompt embeddings 137 to the vector database 143 at block 316. The contextual tokens 146 received from the vector database 143 can represent those tokens which have an encrypted contextual embedding 149 that is similar to one or more of the encrypted prompt embeddings 137.

Then, at block 323, the LLM service 126 can combine the contextual tokens 146 received at block 319 and the prompt tokens 133 generated at block 306 to form an LLM prompt. For example, if the prompt received at block 303 was the phrase “What is a solar eclipse?” that resulted in the tokens [“What”, “is”, “a”, “solar”, “eclipse”, “?”] and the contextual tokens received at block 319 included the tokens [“sun”, “moon”, “Earth”, “orbit”, “pass”, “between”, “total”, “partial”, “annular”], then the LLM service 126 could create an array that combines the two sets of tokens into the single set of tokens [“What”, “is”, “a”, “solar”, “eclipse”, “?”, “sun”, “moon”, “Earth”, “orbit”, “pass”, “between”, “total”, “partial”, “annular”]. This combined set of tokens can be referred to as an LLM prompt. Once the LLM prompt, which represents the combination of the two sets of tokens, is created, the LLM service 126 can provide it as an input to the LLM 129 to cause the LLM 129 to generate a response by iteratively predicting a most likely next word in a sequence of words base on the input of the LLM prompt.

Next, at block 326, the LLM service 126 can receive the response to the LLM prompt from the LLM 129. For example, if the LLM service 126 had provided the LLM prompt to the LLM 129 representing the set of tokens [“What”, “is”, “a”, “solar”, “eclipse”, “?”, “sun”, “moon”, “Earth”, “orbit”, “pass”, “between”, “total”, “partial”, “annular”], the LLM 129 could return a hypothetical response of “A solar eclipse occurs when the moon passes between the sun and the Earth during its orbit around the Earth, thereby blocking the view of the sun from the surface of the Earth. A solar eclipse can be classified as a total, partial, or annular eclipse depending on how much of the sun is blocked by the moon from the surface of the Earth.” The response from the LLM 129 can then be returned to the application or device that provided the prompt to the LLM service 126 at block 303 (e.g., return the response from the LLM 129 to the client application 119 executing on the client device 103).

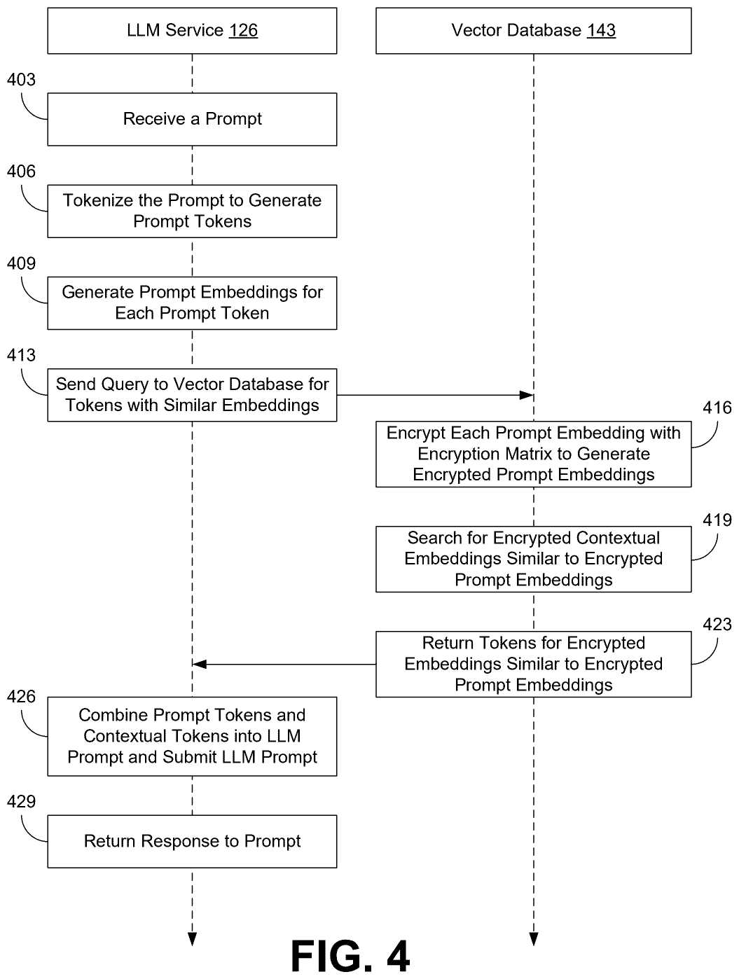

Referring next to FIG. 4, shown is a sequence diagram that provides one example of the operations of portion of the LLM service 126 and the vector database 142 in various embodiments of the present disclosure, such as those depicted in FIG. 1B. The sequence diagram of FIG. 4 provides merely an example of the many different types of functional arrangements that can be employed to implement the operation of the depicted portions of the LLM service 126 and the vector database 142 in various embodiments of the present disclosure. As an alternative, the flowchart of FIG. 4 can be viewed as depicting an example of elements of a method implemented within the network environment 100b.

Beginning with block 403, the LLM service 126 can receive a prompt. For example, the LLM service 126 could receive a prompt from a client application 119 executing on the client device 106. The prompt could be submitted by the client application 119 using a web-based interface (e.g., text entered into a webform on a website), through an application programming interface (API) (e.g., as arguments included in an function call for a function provided by the API), etc.

Next, at block 406, the LLM service 126 can tokenize the prompt received at block 303 to generate one or more prompt tokens 133. Various tokenizing algorithms and delimiters could be used to separate the prompt into one or more lexical tokens representing words, phrases, numbers, symbols, punctuation, etc.

Then, at block 409, the LLM service 126 can generate a prompt embedding 136 for each token generated at block 306. Prompt embeddings 136 can be generated using various language modeling or feature learning techniques, where words, phrases, and/or other tokens are mapped to vectors of real numbers. Examples of these techniques include bag-of-words (BoW) or continuous bag-of-words (CBow) approaches, continuously sliding skip-gram approaches, and transformer architecture approaches. Examples of software for generating embeddings include Tomas Mikolov's word2vec, Stanford's GloVe, and GOOGLE's® Bidirectional Encoder Representations from Transformers (BERT).

Proceeding to block 413, the LLM service 126 can send a query to the vector database 143 to obtain contextual tokens 146 with encrypted contextual embeddings 149 that are similar to the prompt embeddings 136. Accordingly, the query can include the prompt embeddings 136 generated at block 409.

Moving on to block 416, the vector database 143 can encrypt each prompt embedding 136 generated at block 409 with the encryption matrix 139 to generate respective encrypted prompt embeddings 137. This can be done my multiplying each prompt embedding 136 with the encryption matrix 139 to rotate the prompt embedding 136 through its vector space. The matrix resulting from the rotation is the respective encrypted prompt embedding 137 for the prompt embedding 136. The encrypted prompt embeddings 137 can then be temporarily saved or stored in order to search for similar encrypted contextual embeddings 149.

Subsequently, at block 419, the vector database 143 can search for encrypted contextual embeddings 149 that are similar to the encrypted prompt embeddings 137. An encrypted contextual embedding 149 can be considered to be similar to an encrypted prompt embedding 137 according to one or more predefined criteria. For example, an encrypted contextual embedding 149 could be considered to be similar to an encrypted prompt embedding 137 if it is within a predefined Euclidean distance within the vector space occupied by the encrypted contextual embedding 149 and the encrypted prompt embedding 137.

The encryption and search features described in blocks 416 and 419 operate because, as previously described, the encrypted contextual embeddings 149 and the encrypted prompt embeddings 137 have been encrypted with the same encryption matrix 139. Because both sets of embeddings have been encrypted with same encryption matrix 139, all of the embeddings are rotated by the same amount through the same vector space. As a result, their relative positions with respect to each other are preserved the by the rotation performed by the multiplication operation with the encryption matrix 139 that encrypts the embeddings.

Next, at block 423, can identify an associated or respective contextual token 146 for each encrypted contextual embedding 149 identified at block 419 and return it to the LLM service 126. In some instances, individual contextual tokens 146 can be returned as encrypted contextual embeddings 149 are identified. In other instances, the set of contextual tokens 146 that corresponds to the respective set of similar encrypted contextual embeddings 149 can be returned to the LLM service 126 as a group or batch.

Then, at block 426, the LLM service 126 can combine the contextual tokens 146 returned by the vector database 143 at block 423 and the prompt tokens 133 generated at block 406 to form an LLM prompt. For example, if the prompt received at block 403 was the phrase “What is a solar eclipse?” that resulted in the tokens [“What”, “is”, “a”, “solar”, “eclipse”, “?”] and the contextual tokens returned at block 423 included the tokens [“sun”, “moon”, “Earth”, “orbit”, “pass”, “between”, “total”, “partial”, “annular”], then the LLM service 126 could create an array that combines the two sets of tokens into the single set of tokens [“What”, “is”, “a”, “solar”, “eclipse”, “?”, “sun”, “moon”, “Earth”, “orbit”, “pass”, “between”, “total”, “partial”, “annular”]. This combined set of tokens can be referred to as an LLM prompt. Once the LLM prompt, which represents the combination of the two sets of tokens, is created, the LLM service 126 can provide it as an input to the LLM 129 to cause the LLM 129 to generate a response by iteratively predicting a most likely next word in a sequence of words base on the input of the LLM prompt.

Moving on to block 429, the response from the LLM 129 can then be returned to the application or device that provided the prompt to the LLM service 126 at block 403 (e.g., return the response from the LLM 129 to the client application 119 executing on the client device 103).

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
tokenize a prompt to generate a plurality of prompt tokens;
generate a respective prompt embedding for each of the plurality of prompt tokens, the respective prompt embedding for each of the plurality of prompt tokens representing an encoding of each of the plurality of prompt tokens in a high-dimensional vector space; and
encrypt the respective prompt embedding for each of the plurality of prompt tokens by rotating the respective prompt embedding through the high-dimensional vector space to generate a respective encrypted prompt embedding for each of the plurality of prompt tokens.

2. The system of claim 1, wherein the machine-readable instructions further cause the computing device to at least:
send the respective encrypted prompt embedding for each of the plurality of prompt tokens to a vector database; and
receive a responsive set of contextual tokens from the vector database.

3. The system of claim 2, wherein the machine-readable instructions further cause the computing device to at least:
combine the plurality of prompt tokens and the responsive set of contextual tokens into a large language model (LLM) prompt; and
submit the LLM prompt to an LLM.

4. The system of claim 3, wherein the machine-readable instructions further cause the computing device to at least:
receive a response from the LLM to the LLM prompt; and
return the response from the LLM to a provider of the prompt.

5. The system of claim 1, wherein the machine-readable instructions that cause the computing device to encrypt the respective prompt embedding for each of the plurality of prompt tokens by rotating the respective prompt embedding through the high-dimensional vector space further cause the computing device to multiply each respective prompt embedding with an encryption matrix.

6. The system of claim 5, wherein the encryption matrix is pre-shared with a vector database that includes a responsive set of contextual tokens.

7. The system of claim 5, wherein the encryption matrix is a unitary matrix or a rotation matrix.

8. A method, comprising:
tokenizing a prompt to generate a plurality of prompt tokens;
generating a respective prompt embedding for each of the plurality of prompt tokens, the respective prompt embedding for each of the plurality of prompt tokens representing an encoding of each of the plurality of prompt tokens in a high-dimensional vector space; and
encrypting the respective prompt embedding for each of the plurality of prompt tokens by rotating the respective prompt embedding through the high-dimensional vector space to generate a respective encrypted prompt embedding for each of the plurality of prompt tokens.

9. The method of claim 8, further comprising:
sending the respective encrypted prompt embedding for each of the plurality of prompt tokens to a vector database; and
receiving a responsive set of contextual tokens from the vector database.

10. The method of claim 9, further comprising:
combining the plurality of prompt tokens and the responsive set of contextual tokens into a large language model (LLM) prompt; and
submitting the LLM prompt to an LLM.

11. The method of claim 10, further comprising:
receiving a response from the LLM to the LLM prompt; and
returning the response from the LLM to a provider of the prompt.

12. The method of claim 8, wherein encrypting the respective prompt embedding for each of the plurality of prompt tokens by rotating the respective prompt embedding through the high-dimensional vector space further comprises multiplying each respective prompt embedding with an encryption matrix.

13. The method of claim 12, wherein the encryption matrix is a unitary matrix.

14. The method of claim 12, wherein the encryption matrix is a rotation matrix.

15. A non-transitory, computer-readable medium, comprising machine-readable instructions that, when executed by a processor of a computing device, cause the computing device to at least:
tokenize a prompt to generate a plurality of prompt tokens;
generate a respective prompt embedding for each of the plurality of prompt tokens, the respective prompt embedding for each of the plurality of prompt tokens representing an encoding of each of the plurality of prompt tokens in a high-dimensional vector space; and
encrypt the respective prompt embedding for each of the plurality of prompt tokens by rotating the respective prompt embedding through the high-dimensional vector space to generate a respective encrypted prompt embedding for each of the plurality of prompt tokens.

16. The non-transitory, computer-readable medium of claim 15, wherein the machine-readable instructions further cause the computing device to at least:
send the respective encrypted prompt embedding for each of the plurality of prompt tokens to a vector database; and
receive a responsive set of contextual tokens from the vector database.

17. The non-transitory, computer-readable medium of claim 16, wherein the machine-readable instructions further cause the computing device to at least:
combine the plurality of prompt tokens and the responsive set of contextual tokens into a large language model (LLM) prompt; and
submit the LLM prompt to an LLM.

18. The non-transitory, computer-readable medium of claim 17, wherein the machine-readable instructions further cause the computing device to at least:
receive a response from the LLM to the LLM prompt; and
return the response from the LLM to a provider of the prompt.

19. The non-transitory, computer-readable medium of claim 15, wherein the machine-readable instructions that cause the computing device to encrypt the respective prompt embedding for each of the plurality of prompt tokens by rotating the respective prompt embedding through the high-dimensional vector space further cause the computing device to multiply each respective prompt embedding with an encryption matrix.

20. The non-transitory, computer-readable medium of claim 19, wherein the encryption matrix is a unitary rotation matrix.
